(19) United States
(12) Patent Application Publication
(10) Pub. No.: US 2005/0102368 A1
(43) Pub. Date: May 12, 2005

(54) Email attribute system using external databases

(76) Inventors: George H. Forman, Port Orchard, WA (US); Kave Eshghi, Los Altos, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/706,407

(22) Filed: Nov. 12, 2003

(51) Int. Cl. G06F 15/16

(52) U.S. Cl. 709/207; 709/245

(57) ABSTRACT

Auxiliary, or external, information is used to assist in handling email addresses by allowing additional characterizations of the addresses. The additional characterizations can include geographical, organizational, temporal, and other types of information obtained, for example, from databases external to the email system. An email system can access information in a company's enterprise database to obtain organizational information such as names of people under a given manager, people in a specific building, people who have attended a meeting, etc. Characterizations can be used with traditional email information to create an email group, a search or sort filter, etc.

### BACKGROUND OF THE INVENTION

Electronic mail, or email, has become an extremely valuable communication tool. Email is increasingly being used as the preferred way to transfer text, images, audio, and other information. It is almost essential that any viable business provide email access to employees using desktop computers connected through a corporate local-area network (LAN) and the Internet. Portable email access devices include laptop computers with wired or wireless access to networks; cell phones, personal digital assistants (PDAs), and other portable devices for accessing email. Future devices promise to make email access even easier and more commonplace.

One drawback with the heavy use of email is that a burden is placed on an email user to organize dozens, hundreds or even thousands or more email correspondents with whom the user desires to communicate. Present email systems, such as Outlook™ developed and distributed by Microsoft, Corp.; and other email applications by, e.g., by Netscape, Inc., Apple, Inc., etc., all provide features, or “tools,” to assist users in organizing, and sending email to, correspondents.

A problem is encountered when searching for past email stored, for example, in a user's “archive” folder. Sometimes a user tries to filter a large number of email messages to discover the one email message that they vaguely recall. For example, a user may wish to find an email received a few months ago from someone in a specific project group from a specific division. The user may recall generalities about the person who sent the email, or about the email, itself, without recalling any of the identifiers present in the email address.

A basic tool provided by email systems is to automatically store email addresses from email that is received by, or sent to, the user. Such automatically recorded address lists are then used when a user enters an email address by manually typing the address or name on a keyboard. The system looks at the partial name as the user is typing and attempts to match the name in the list of previously-stored names. When a match is encountered the name is automatically completed, thus saving the user typing. This feature is also useful if a user cannot remember the entire name or address, but only remembers the beginning. However, unless a user has received a recent email from a correspondent the user's local address list may be outdated. Some email systems will check a corporate directory to complete the alphabetic spelling of a name. However, this is only an aid to memory based on partially remembered name or address and does not allow the user to use other attributes of the intended recipient.

Email systems allow information to be associated with a correspondent. For example, a correspondent's email address may be a complex and hard-to-remember string of letters, numbers and other symbols such as “Emily.smith@am.corp23.com”. Although this address is difficult to remember, the address list can associate the name “Emily Smith” with the address so that a user can use either the correspondent's name or the email address to send an email. Other information, such as a nickname, can be associated with the correspondent.

Address lists are also used to store and identify characteristics of, and groupings for, various correspondents. For example, a typical email address in a so-called Uniform Email Address (UEA) format will include a first name, a period, the last name, an ampersand, a country code, a period, a business name (sub-domain), a period and a domain name such as “com,” “net,” “edu” etc. Such a format is useful, for example, to identify correspondents from a specific company, or international branch of a company. A “group” of correspondents can be automatically created, filtered, or selected based on the existence of any of the identifiers in the UEA-format email address. This allows a user to easily send email to everyone in the user's address book, but only insofar as they are classifiable by the email address format.

A drawback with address lists is that since the UEA contains very limited information it is often the case that a user wants to send email to a group that cannot be created, or addressed, automatically. For example, a user may want to send email to some members of a company that are not present in a user's address list. Or the user may want to exclude some members of the company that are in the user's address list. Also, if a user wants to further classify the recipients of an email, such as to members of a project group within a company, people in a specific building, on a specific floor, etc., then the user is usually forced to create the list by manually entering, or selecting, each member of the group.

Thus, address books, group lists or other traditional approaches may be insufficient to handle the needs of today's email users.

### SUMMARY OF AN EMBODIMENT OF THE INVENTION

One embodiment of the invention provides a method for selecting an email address, wherein the email address includes a format, the method comprising defining at least one auxiliary criterion, wherein the auxiliary criterion uses information in addition to the format of the email address; and using the auxiliary criterion to identify the email address.

### BRIEF DESCRIPTION OF THE DRAWINGS

FIG. 1 shows an organization of hardware devices used to practice the invention in an exemplary embodiment;

FIG. 2 shows a flowchart of a routine for defining an email group in accordance with embodiments of the invention;

FIG. 3 shows a flowchart of a routine for searching a local email folder in accordance with embodiments of the invention;

FIG. 4 is an example of an enterprise directory entry in accordance with embodiments of the invention; and

FIG. 5 shows an extended search dialog box in accordance with embodiments of the invention.

### DETAILED DESCRIPTION OF EMBODIMENTS OF THE INVENTION

Auxiliary or external information is used to assist in processing email by allowing additional characterizations of the addresses. The additional characterizations can include geographical, organizational, temporal, and other types of information obtained, for example, from databases external to the email system. An email system can access information in a company's enterprise database to obtain organizational information such as people under a given manager, people in a specific building, people who have attended a meeting, etc. Criteria can be used to quickly form an email group, create a search or sort filter, or can be combined with other criteria, including traditionally available email information.

In one embodiment, external corporate databases are used to provide characteristics associated with email correspondents to assist an email user in addressing, filtering, searching or other email operations. For example, an email system can access information in a company's enterprise database to obtain organizational information such as identifying people under a given manager. This allows a criterion such as “all employees who are managed by Susan Smith” to be used in addressing, filtering, searching, sorting, or other email operations. Information from a facilities database can be used to form a criterion such as “all people in building 5.” Information from a human resources database can be used so that a search criterion that asks for “employees over 30 who are salaried” can be used.

The criteria can be used to quickly form an email group, create a search or sort filter, be combined with other criteria (including traditional email information), etc. Other types of databases can yield characteristics or other information to form other useful queries or conditions. Databases of other companies can be used. Databases from devices such as personal computers, laptops, personal digital assistants (PDAs), etc. can be used.

The characteristics can be used to, e.g., search email repositories by combining information in the email message, itself, with information from an external database. For example, a sender's name, date of the message, etc., can be combined with corporate directly information such as the sender's department, location, job title, etc. Traditional email tools, such as using rules for automatic sorting of email into different folders, can be used with characteristics obtained from external databases. For example, a rule to “put all messages from anyone in Human Resources in the HR subfolder” can be created and applied. Custom archiving of email messages is also possible such as to “archive all messages to and from people in the legal department for a period of time according to the current corporate holding policy.”

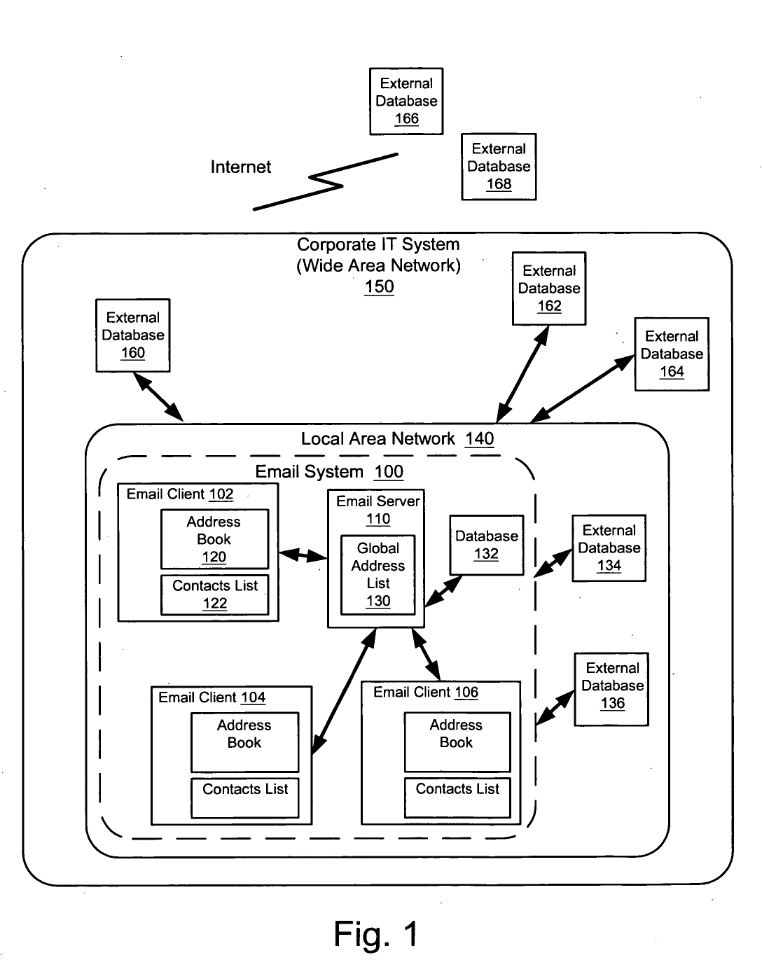

In FIG. 1, email system 100 includes multiple email clients 102, 104 and 106. The email clients are coupled to email server 110 for centralizing distribution of email to the clients, transferring email outside of the email system and other coordination and control. Typically there will be several dozen, or even hundreds or thousands, of email clients and there may be multiple email servers. FIG. 1 is intended to convey only a few basic features of a conceptual email system for purposes of illustration of embodiments of the invention. Note that although specifics of an email system are discussed herein, any suitable arrangement of hardware and software components can be used with the invention.

Although email systems are generally described in terms of client and server machines and processes, any type of communication or network arrangement, scheme or topology can be used with the present invention. Although client/server systems generally imply that different functions are expected of a client, as opposed to a server, an email system suitable for use with the present invention may be implemented with any arbitrary functionality performed by the client, server or both. In some designs, e.g., peer-to-peer, application-specific provider, etc., there may not be identifiable client or server processes. Any suitable protocol (e.g., Internet Message Access Protocol (IMAP), Post Office Protocol (POP), etc.), syntax or communication method can be used.

The email server stores and transfers email traffic and data for multiple email clients. Each email client also is also typically provided with storage, control, management and other resources and processes that are usually tailored to a particular user's needs. For example, email client 102 is shown having a local address book 120 and contacts list 122. These stored databases allow a user to look up previously used, or known, email addresses. An email client process can also automatically try to match partial addresses that the user is typing, with full addresses stored in the address book, contacts list, or other database that is local to the email client. Typically, the databases that are local to an email client are those that are relevant to a particular user. E.g., based on email that a particular user of the email client has sent or received. Different types of data can be stored at databases in the email clients. For example, the contacts list will include a physical address, phone number, organization, etc., associated with an email address.

An email server can have local data stores, or databases, that are local to the email server. For example, email server 110 includes global address list 130. The global address list typically includes the addresses of all users operating the email clients. There may be a record of addresses captured from email that has passed through the email server so that, for example, all email addresses for all clients may be stored in a database at the email server. Other data structures relating to an email system may be created by, or stored in, the email server.

An email server may be provided with group address lists that are accessible by the email clients. For example, a group address list can include email addresses of company employees in a specific department or working on a specific project; those employees having an office space on a particular floor of a building; etc. Such group address lists can be prepared by an administrator and stored for everyone's use in a group list on the email server.

The server can be provided with other resources, such as database 132, which can be a process executing within the email server or executing on a device in communication with the email server.

Email system 100 is usually interconnected by a LAN. In cases where companies span multiple buildings at different geographic locations, multiple LANs are interconnected with a wide-area network (WAN) arrangement. Many other types of “area networks” are possible such as a metropolitan area network (MAN), small area network (SAN), personal area network (PAN), etc. Other types of networks are defined by their function, such as a storage area network (SAN), etc. In general, any type of network or interconnection arrangement and topology can be used with various embodiments of the invention.

External databases 134 and 136 are typically corporate, or enterprise, databases that are owned, maintained and controlled by, or under the supervision of, a company that operates the email system as a tool for the company's employees. Such databases can be associated with any department, operation or function, or other aspect of a company's business. Examples of corporate databases include, e.g., human resources, payroll, benefits, departmental, organizational, etc. Any type of record or information can be stored in the databases coupled to a company's networks. For example, medical, tax, resume, biographical, educational, and other records may be stored.

FIG. 1 also shows overall corporate information technology (IT) system including WAN 150 connecting external databases 160, 162 and 164 and LAN 140. Additional resources, such as additional external databases 166 and 168, are accessible over other communication channels such as the Internet.

One embodiment of the invention uses auxiliary information, such as that residing in external corporate databases, to associate additional characteristics or information with email addresses. The additional characteristics can then be used in addressing, searching, sorting, filtering and other email functions by forming a “criterion” than can include e.g., relational expressions and the characteristics. Although a preferred embodiment of the invention obtains the additional characteristics data from external databases, other embodiments can obtain the data from other sources, including locally or internally to the email system. In general, functions described herein can take place in any geographical location, within any device and by any suitable process or processor. Data and databases can similarly reside at any point in an email system or in an overall corporate (or other) IT system. Functions can be executed, and data can reside, spread across multiple components of hardware and software. Functions can be performed at different points in time, in parallel, or dynamically in real-time or “offline” in a pre-processing, or “batch” mode. Embodiments of the invention allow an email system to take advantage of additional information (i.e., characteristics) of email correspondents to provide enhanced, or new, features relating to email. Although a preferred embodiment of the invention is directed to a corporate or business application, other embodiments can be directed to any type of email system and environment.

Information in databases in a corporate IT system can be extensive. Almost every aspect and detail of the company is kept in a computerized record. One problem with such an approach is that the information is usually copied and disseminated to different locations, departments, projects, etc. The disseminated information often becomes outdated but may still be relied upon. For example, a corporate telephone directory, office and mail stop listing, organization chart, etc., are all types of information that are changed frequently yet exist in many places and databases that are not updated as often as the information is changed.

One approach of the invention ensures accuracy by obtaining the information from a creator or maintainer. For example, a mail room database is more likely to have accurate employee physical location information than a human resources database. A corporate headquarters database is more likely to have accurate organizational information, including managers' names and assigned groups, than other sources. Providing the email system with access to an originating source of data ensures data accuracy without placing a burden on the email system or users to make updates. Any method may be used to transfer data from a database to an email system. For example, the popular Lightweight Directory Access Protocol (LDAP) can be adapted.

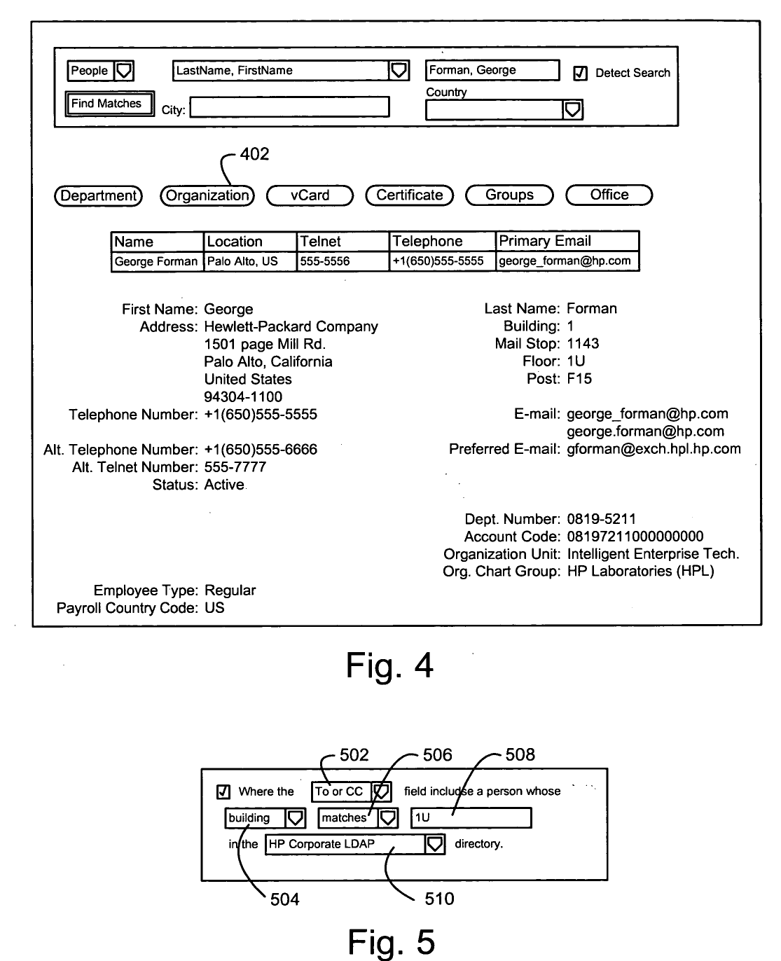

Corporations often maintain enterprise directories that can be used for obtaining additional information (i.e., “characteristics”) of email users. For example, FIG. 4 shows a typical enterprise directory entry for an employee. The entry includes city, building, floor, post, organization and other information. The directory also shows the employee's manager. The organization hierarchy can be discovered by following a link to the employee's manager associated with Organization button 402. The manager's enterprise directory page invoked by the link will, in turn, show the manager's manager and so on. The management information can be parsed by a process that scans web pages in the directory (e.g., a search engine such as Google™, Altavista™, etc.) to acquire characteristic information for the email system. Other information relevant to the employee can be found by scanning pages pointed to by links from the directory entry.

One use of the additional information can be to combine the additional information with standard information in an email message, such as a sender's name, date of the message, etc. Thus, queries that include relational combinations of standard and additional characteristics can be used for addressing, searching, filtering, managing and other email-related tasks. For example, an email user can make a query such as “find all messages in my archive mailbox sent to me in September from individuals whose manager is John Doe.”

Another use of the additional information is to create custom email groups. For example, a group can be defined that includes email users “whose office is in building 1U, and who are not part of the RIT project”. Any number and type of group definitions can be made. The email system can use information from personal or shared electronic schedules. This would allow sending a message to, e.g., “people who will be out of the office next Tuesday.” Further examples include defining a group of “attendants at a shareholder's meeting,” “people whose parking passes are about to expire,” etc.

The same definitions, queries or other criteria can be used as input to standard email tools and features. For example, sorting rules can be defined as described above so that, if the criteria are met, an incoming email is placed into a specific email folder. Custom archiving of email messages can be achieved. For example, “email from the legal department is to be archived and the archive deleted after a time interval as described in the company's guidelines.” Any manner of criteria using the additional information or characteristics can be used.

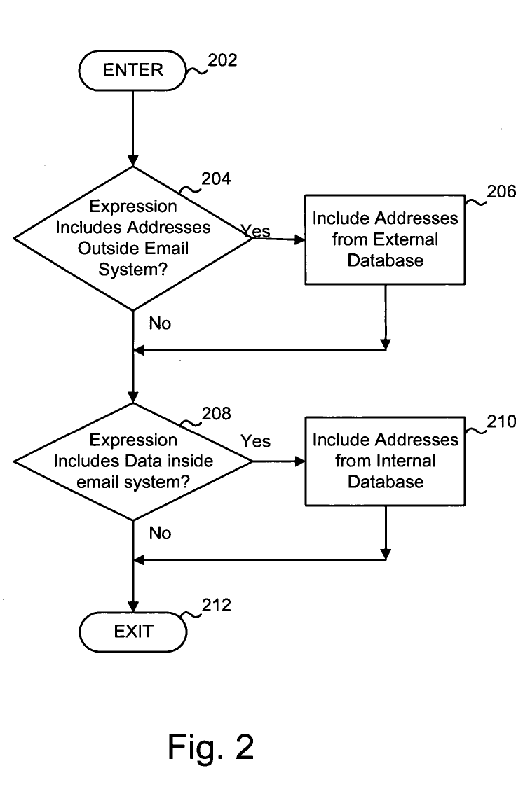

FIG. 2 shows a flowchart of a routine for defining an email group.

In FIG. 2, a user desires to define a group to which to send an email message. However, the group is not pre-defined and, also, will include email addresses that are not currently within the email system. In other words, some of the email addresses that fall within the group definition criterion are not in the user's client databases or in the server's databases or associated databases. For example, a user at XYZ Company might desire to send an email to employees of ABC Corp. who attended a specific meeting last week.

The flowchart of FIG. 2 is entered at 202 after the user has entered a text string including relational expression that defines the group. At step 204 a check is made as to whether the expression might include email addresses not stored in the email system's databases. If so, execution proceeds to step 206 where any addresses meeting the expression's criteria is obtained. In the present example, the email system detects that ABC Corp's databases must be consulted so the appropriate query is sent over the Internet to ABC Corp where, assuming permission is granted, the appropriate ABC Corp databases are checked to see if any ABC Corp employees are indicated as having attended the meeting. If so, those addresses are supplied to XYZ Company's email system.

If the expression does not require email addresses outside of the email system, or after such outside email addresses have been obtained at step 206, execution proceeds to step 208 where a check is made as to whether the expression references data inside the email system. If so, step 210 is executed to obtain any email addresses from XYZ Company's email system. Assuming the user did not limit the scope of the group to non-employee's of XYZ Company, the XYZ Company employees who attended the meeting would be added to the group. The routine terminates at step 212 after all of the email addresses are compiled into a group definition.

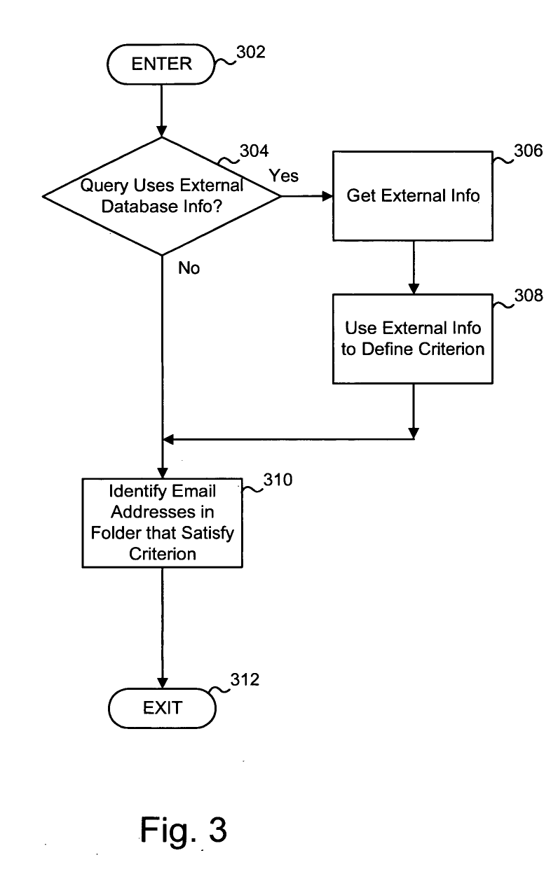

FIG. 3 shows a flowchart for searching a local folder where a query references information that is external to an email system.

In FIG. 3, the routine is entered at step 302 after a user has supplied a query that uses information external to the user's email system. A check is made at step 304 as to whether the query uses external database information. If so, execution proceeds to step 306 where external information is obtained. For example, if a user desires to filter email messages in the user's in-box to find “messages that were sent by people who are managed by Manager A” then step 306 performs a query on the enterprise directory to determine a list of user's who are managed by Manager A. The list is transferred to the user's email client and is used at step 308 to define the criterion as requiring the “sender's” field of a message to include a name that is in the list.

Another way to do a matching operation more efficiently when the source of messages being filtered (e.g., an in-box) has relatively fewer names and messages than the external database is to compile a list of the relevant information from the email messages in the source (e.g., the list of unique email addresses appearing in the in-box) and send the list to the database server (e.g., LDAP server). The database server can then successively process each list item against characteristics in the database by using a provided criterion to determine whether the list item satisfies the criterion. The results of the processing, e.g. a list of the satisfying email addresses, is sent back to the email system where, e.g., a list of the satisfying email messages is presented to the user and the rest of the messages (non-satisfying messages) are omitted from the display, or are “filtered out.”

At step 310 the criterion is used to identify the desired messages in the user's in-box. The criterion can include internal as well as external information (assuming steps 306 and 308 were executed). The routine exits at step 312.

Employees supervised by any given manager can be determined by consulting a database that maintains management relationships and other employee data. In a preferred embodiment, management and other data are obtained by making queries of database. In other embodiments, data can be obtained in other ways such as by parsing pages of an enterprise directory recursively, or successively, until all people under a given manager are identified. A backwards search is also possible where a list of all employees is used to exhaustively check which managers are parts of each employee's management hierarchy. In such a case, caching the lists would be useful to minimize database lookups.

In one embodiment, a standard email client can be modified to achieve features of the invention, including directory-based searching, sending and filtering. The email client is modified so that it can access an external database, such as a corporate directory server, or other address book databases, such as a personal contact list in, e.g., a standard email program, web-based email access, a personal digital assistant (PDA), etc. The email client can also be provided with an extended email search dialog box. Such an extended search dialog box can present a user with templates for a search. For example, FIG. 5 shows an extended search dialog box where a user can select email field 502, characteristic 504, condition 506, value 508 and source 510.

A field can be, e.g., the “To,” “CC,” “From” or “BCC” fields. Although a preferred embodiment primarily focuses on these email address fields (or other person identifier field used to specify people or email addresses) other embodiments may advantageously use features of the invention in other information associated with an email message such as the “Attachment,” “Subject,” “Body” or any other parts of an email message. A characteristic can be a building name; country, state or other geographic location; manager name; project name, etc. A condition can be if part of the email address “matches,” “does not match,” or is “below,” “above,” “within a 2 mile radius,” or “reports under X in the organization hierarchy,” or other types of conditions, depending on the characteristic selected. A value will, similarly, depend on the characteristic selected. If a partial value (e.g., a part of a name) is supplied then a closest match will be attempted and the best match will be displayed in the value field when the user advances out of the value field box. The source can be any directory in a list of available directories, both inside and outside of the user's own company.

For the example in FIG. 5, each person identified in the “To or CC” fields will be looked up in the “HP Corporate LDAP” directory. The directory can be cached, or stored locally once originally fetched, for a short period of time, as desired. The selection “building” is extracted from the LDAP and matched against the string “1U”. In one embodiment, a value of “null” can be returned if, for example, an external database is searched for a different company and there is no such thing as a building field in the external database. This approach can also handle search requests such as “people who are marked ‘family’ in the notes field of my PDA address book” or “people whose organization chart group contains ‘HPL’ in the company LDAP directory.” Any other types of queries are possible.

A group of email addresses can be automatically generated from queries such as those described above. The group name used can be descriptive, rather than providing the entire list of email addresses. For example, the name of the group in the example of FIG. 5 can be “People in building 1U”. The group can then be stored as a distribution list that is invoked whenever the name is used in an email (or person identifier) field.

Although the invention has been discussed with respect to specific embodiments thereof, these embodiments are merely illustrative, and not restrictive, of the invention. For example, any suitable programming language can be used to implement the routines of the present invention including C, C++, Java, assembly language, etc. Different programming techniques can be employed such as procedural or object oriented. The routines can execute on a single processing device or multiple processors. Although the flowchart format demands that the steps be presented in a specific order, this order may be changed. Multiple steps can be performed at the same time. The flowchart sequence can be interrupted. The routines can operate in an operating system environment or as stand-alone routines occupying all, or a substantial part, of the system processing.

Steps can be performed in hardware or software, as desired. Note that steps can be added to, taken from or modified from the steps in the flowcharts presented in this specification without deviating from the scope of the invention. In general, the flowcharts are only used to indicate one possible sequence of basic operations to achieve a functional aspect of the present invention.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” includes any system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of the present invention can be achieved by any means as is known in the art. Distributed or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

1. A processor-based method for selecting an email address, wherein the email address includes a format, the processor-based method comprising:
defining at least one auxiliary criterion, wherein the auxiliary criterion uses information in addition to information in an email associated with the email address; and
using the auxiliary criterion to identify the email address.

2. The processor-based method of claim 1, wherein the step of defining at least one auxiliary criterion includes a substep of
accepting a signal from a user input device to at least partially define the at least one auxiliary criterion.

3. The processor-based method of claim 1, wherein the step of defining at least one auxiliary criterion includes a substep of
using a processor to at least partially define the at least one auxiliary criterion.

4. The processor-based method of claim 1, wherein the identified email address is part of a search request.

5. The processor-based method of claim 1, wherein the identified email address is part of an addressing request.

6. The processor-based method of claim 5, further comprising:
using the auxiliary criterion to determine a group of email addresses.

7. The processor-based method of claim 6, wherein the step of indicating the determined group includes a substep of
recording an indication of the determined group in a “to” line in an email message header.

8. The processor-based method of claim 1, wherein the step of defining is performed by a local processor coupled to an external database remote from the local processor, wherein the auxiliary criterion is used to access information in the external database.

9. The processor-based method of claim 8, wherein the external database includes a corporate database.

10. The processor-based method of claim 8, wherein the external database includes an enterprise database.

11. The processor-based method of claim 8, wherein the external database includes a remote database accessed via the Internet.

12. The processor-based method of claim 1, wherein the auxiliary criterion includes a manager's name.

13. The processor-based method of claim 1, wherein the auxiliary criterion includes a department name.

14. The processor-based method of claim 1, wherein the auxiliary criterion includes a company division name.

15. The processor-based method of claim 1, wherein the auxiliary criterion includes an identification of a project.

16. The processor-based method of claim 1, wherein the auxiliary criterion includes an identification of a meeting.

17. The processor-based method of claim 1, wherein the auxiliary criterion includes a geographic location.

18. An apparatus for selecting an email, wherein the email includes a format, the apparatus comprising:
a process for handling email messages;
a process for accepting an auxiliary criterion selected by the user, wherein the auxiliary criterion uses information in addition to the information in an email associated with the email address; and
a process for using the auxiliary criterion to select an email.

19. The apparatus of claim 18, further comprising:
accepting a signal from a user input device to at least partially define the auxiliary criterion.

20. The apparatus of claim 18, further comprising:
using a processor to at least partially define the auxiliary criterion.

21. The apparatus of claim 18, wherein a selected email is part of a search request.

22. The apparatus of claim 18, wherein a selected email is part of an addressing request.

23. An apparatus for selecting an email address, wherein the email address includes a format, the apparatus comprising:
means for accepting an auxiliary criterion selected by the user, wherein the auxiliary criterion uses information in addition to the format of the email address; and
means for using the auxiliary criterion to identify the email address.

24. The apparatus of claim 23, further comprising:
accepting a signal from a user input device to at least partially define the auxiliary criterion.

25. The apparatus of claim 23, further comprising:
using a processor to at least partially define the auxiliary criterion.

26. The apparatus of claim 23, wherein an identified email is part of a search request.

27. The apparatus of claim 23, wherein an identified email is part of an addressing request.

28. A computer-readable medium including instructions for identifying an email, wherein the email includes a format, the computer-readable medium comprising:
one or more instructions for accepting an auxiliary criterion selected by the user, wherein the auxiliary criterion uses information in addition to the format of the email; and
one or more instructions for using the auxiliary criterion to identify the email.

29. The computer-readable medium of claim 28, further comprising:
one or more instructions for accepting a signal from a user input device to at least partially define the auxiliary criterion.

30. The apparatus of claim 29, further comprising:
one or more instructions for using a processor to at least partially define the auxiliary criterion.

31. The apparatus of claim 29, wherein an identified email is part of a search request.

32. The apparatus of claim 29, wherein an identified email is part of an addressing request.

33. A processor-based method for filtering a group of email messages, wherein the email messages include information, the processor-based method comprising:
defining at least one auxiliary criterion, wherein the auxiliary criterion uses information in addition to the information included in the email messages; and
using the auxiliary criterion to identify at least one of the email messages.

34. The processor-based method of claim 33, further comprising:
indicating email messages, from the group of email messages, that meet the auxiliary criterion.

35. The processor-based method of claim 34, further comprising:
generating a display of email messages; and
wherein at least one of the group of email messages are omitted from the display of email messages.

36. The processor-based method of claim 33, wherein the step of defining is performed by a local processor coupled to an external database remote from the local processor, wherein the auxiliary criterion is used to access information in the external database.
